(19) United States
(12) Patent Application Publication
(10) Pub. No.: US 2025/0038424 A1
(43) Pub. Date: Jan. 30, 2025

(54) MULTI-BEAM ANTENNA ARRAY

(71) Applicant: All.Space Networks Limited, Reading (GB)

(72) Inventors: John-Paul Szczepanik, Esher (GB); Richard Keeton, Lymington (GB); Vikas Sharma, Reading (GB); Maria Papaioannou, Reading (GB); Derek De Jager, Reading (GB); Sarmad Al-Taei, Reading (GB); Kevin Savage, Wokingham (GB); Massimo Candotti, Camberley (GB); lan Willmott, Hermitage (GB); Nicholas Leonard Long, Reading (GB); Jeremiah P. Turpin, Linthicum, MD (US); John Finney, London (GB)

(21) Appl. No.: 18/696,763

(22) PCT Filed: Sep. 20, 2022
(86) PCT No.: PCT/GB2022/052371

§ 371 Date: Mar. 28, 2024

(30) Foreign Application Priority Data
Sep. 29, 2021 (GB) 2113903.5

(51) Int. Cl. H01Q 21/00; H01Q 19/06; H01Q 21/20; H01Q 25/00

(52) U.S. Cl. CPC H01Q 21/0025; H01Q 19/062; H01Q 21/0031; H01Q 21/20; H01Q 25/008

(57) ABSTRACT

There is disclosed a multi-beam antenna array, comprising a main array of antenna modules, each antenna module comprising a plurality M of individually-steerable antenna elements. The antenna modules are arranged in the main array with N-fold rotational symmetry, the antenna elements are arranged within each module with M-fold rotational symmetry, and each antenna element comprises a sub-array of radiating elements.

This disclosure relates to a multi-beam antenna array, a satellite communications terminal comprising a multi-beam antenna array, a system comprising a plurality of satellite communications terminals, and methods of operation thereof. In certain aspects, the disclosure relates to an improved VSAT SATCOM terminal composed of an electrically-steered multi-beam lens-array radiating aperture; a containing housing, radome, and base; mounting features for installing to a fixed or mobile platform, and modular bays for the power supply and other end-user customizable hardware.

### BACKGROUND

Conventional satellite communications (SATCOM) terminals are assembled or integrated from a number of different discrete components, which typically include an antenna, a block upconverter (BUC), a low-noise block (LNB) downconverter, an antenna controller (in the case of steerable antennas), and a modem. These components may be assembled in a single location, or distributed across a greater or smaller area with long cable or packet network connections between components. The combination of these components, when properly configured, is then referred to as the SATCOM terminal, functioning as a single unit for communications purposes with the modem acting as the interface for the end user. Terminals that are intended to operate while on-the-move (such as those mounted to vehicles) must include antennas that are steerable in terms of the direction they are pointed relative to the platform on which they are mounted. Steering or pointing the antenna can be done mechanically, in the case of parabolic reflectors or gimbaled flat-panel antennas, or can be performed electronically in the case of electrically-steered antennas such as phased arrays, metamaterial antennas, and lens arrays. Electrically-steered antennas have been challenged in the market due to high power consumption and cost, but offer benefits in terms of beam steering agility and speed and the potential to offer multiple beams pointed from the same antenna, something that mechanically steered apertures cannot offer.

Integrated terminals with all of the respective components combined into a single package have been constructed previously for both electrically-steered antennas and mechanically steered antennas, such as the Kymeta® U8 terminal. Terminals containing lens array antennas have been described by the present Applicant in WO 2018/167717, the full disclosure of which is incorporated herein by reference.

### BRIEF SUMMARY OF THE DISCLOSURE

Viewed from a first aspect, there is provided a multi-beam antenna array, comprising:
a main array of antenna modules, each antenna module comprising a plurality M of individually-steerable antenna elements;
wherein the antenna modules are arranged in the main array with N-fold rotational symmetry;
wherein the antenna elements are arranged within each module with M-fold rotational symmetry; and
wherein each antenna element comprises a sub-array of radiating elements.

Each antenna module may comprise at least three individually-steerable antenna elements.

More generally, each antenna module may comprise M individually-steerable antenna elements, where M is an integer greater than 1, preferably at least 3.

Each antenna module may comprise the same number of individually-steerable antenna elements.

The antenna modules may be arranged in a substantially circular or regular polygonal arrangement.

The antenna modules may be arranged in a plurality of nested, substantially concentric circles or regular polygons.

Some of the antenna modules may be configured as transmit antenna modules and a remainder of the antenna modules may be configured as receive antenna modules.

Each substantially concentric circle or polygon may comprise only transmit antenna modules or only receive antenna modules.

An outermost circle or polygon may comprise transmit antenna modules, and an innermost circle or polygon may comprise receive antenna modules. In some embodiments, the outermost circle or polygon may comprise transmit antenna modules, and the inner circles or polygons may comprise receive antenna modules.

The antenna modules may be mounted on a substrate. The substrate may be a parallel combiner slice (PCS). The substrate may be a one-piece substrate. Alternatively, the substrate may comprise a plurality N of tiled sections. The N tiled sections may have substantially the same shape as each other so as to tile together to form a shape with N-fold rotational symmetry. Each of the N tiled sections of substrate may have a substantially identical arrangement of antenna modules mounted thereon.

The antenna array may be configured such that beams formed by the individually-steerable antenna elements are steered in an analog domain. The beams can be steered by adjusting the phase, or the magnitude (amplitude), or the phase and the magnitude (amplitude) of analog signals such as waveforms.

The antenna array may be configured such that a beam formed by combining the beams formed by the individually-steerable antenna elements is steered in a digital domain. The combined beam may be steered by adjusting the phase, or the magnitude, or the phase and the magnitude, by digital signal processors. Phase adjustment may be effected by introducing time delays or time adjustments by way of a digital signal processor.

Phase adjustment can be made by way of phase shifters, which apply the same phase shift independently of the frequency of the signal. However, this can give rise to beam squint when a wide range of frequencies are being used, as for example in a wideband array. In some embodiments, it may be preferred to use true time delay to apply variable phase shifting across the spectrum of the beam that is being steered. True time delay may be implemented in both the analog and digital domains.

In some embodiments, true time delay phase adjustment is implemented in each sub-array of radiating elements.

The sub-arrays of radiating elements may be configured as evenly-spaced feeds in a circular or regular polygonal grid arrangement.

Alternatively, the sub-arrays of radiating elements may be configured as non-evenly-spaced feeds.

The radiating elements in the sub-arrays may be arranged so as to display M-fold rotational symmetry together with the antenna elements within each module. This allows for ease of manufacture and assembly.

Alternatively, the radiating elements in the sub-arrays may be arranged so as to not to display M-fold rotational symmetry together with the antenna elements within each module. A slight asymmetry may contribute to producing a smooth scanning profile at the array level together with the rotation of the antenna modules themselves relative to the array as a whole.

Each individually-steerable antenna element may be a lens antenna comprising a dielectric lens.

The radiating elements in each sub-array may be mounted on a printed circuit board (PCB) that connects to the substrate via a connector. The antenna array may further comprise front-end RF circuits or amplifiers mounted on the PCB.

The radiating elements in each sub-array may be mounted on a PCB that connects to the substrate by way of planar surface-mount solder connections. The antenna array may further comprise front-end RF circuits or amplifiers that connect to the PCB by way of planar surface-mount solder connections.

The radiating elements in each sub-array may be mounted on the substrate. The radiating elements in each sub-array may be mounted directly on the substrate. The antenna array may further comprise front-end RF circuits or amplifiers that are mounted on the substrate, optionally directly on the substrate.

The antenna array may be provided with one mixer stage channel and one digital signal processor (DSP) stage channel per sub-array per supported beam.

The antenna array may be configured such that activation of one or more radiating elements within a sub-array controls a radiation pattern of the associated antenna element within the main array.

The antenna array may further comprise control circuitry configured dynamically to activate different numbers of radiating elements within the sub-arrays according to power and performance requirements.

In some particularly preferred embodiments, M=3 and N=6.

In some embodiments, six antenna modules are provided on each tiled section of the substrate.

In the context of the present disclosure, the expression “N-fold rotational symmetry” is used to describe an arrangement of antenna modules that looks substantially the same when the main array is rotated by integral multiples of 360°/N. For example, where N=6, the arrangement of antenna modules in the main array will look substantially the same, when viewed from above, at each rotation by 60° of the array about an axis of rotation extending perpendicularly through the centre of the main array. It will be understood that manufacturing tolerances and cosmetic features are to be disregarded when determining rotational symmetry, and that minor configurational variations that have substantially no functional effect can also be disregarded.

In the context of the present disclosure, the expression “M-fold rotational symmetry” is used to describe an arrangement of antenna elements in an antenna module that looks substantially the same when the antenna module is rotated by integral multiples of 360°/M. For example, where M=3, the arrangement of antenna elements in the antenna module will look substantially the same, when viewed from above, at each rotation by 120° of the antenna module about an axis of rotation extending perpendicularly through the centre of the antenna module. It will be understood that manufacturing tolerances and cosmetic features are to be disregarded when determining rotational symmetry, and that minor configurational variations that have substantially no functional effect can also be disregarded.

Viewed from a second aspect, there is provided a satellite communications terminal comprising the multi-beam antenna array according to the first aspect.

The terminal may be configured such that the antenna modules are disposed within an antenna aperture, and the antenna aperture may be covered with a radome.

The radome may comprise a composite fiber-PTFE fabric and a ring-shaped support structure.

The terminal may further comprise a housing. The housing may include integrated handles for movement and installation. The housing may include integrated hoist points.

The housing may comprise a plurality of bays. Each bay may be configured to receive one or more electronic modules. Examples of such electronic modules include: power supplies, analog modems, digital modems, computers, cellular gateways, network switches, routers etc. The bays may be configured to allow easy field reconfiguration of the terminal by swapping electronic modules between bays, or adding new electronic components to empty bays. The bays may be provided with electrical connectors configured for pluggable engagement with corresponding electrical connectors on the electronic modules. The electrical connectors may be of an industry standard configuration, such as one or more of the various Universal Serial Bus (USB) standards, or may have a custom configuration.

Two or more terminals of the second aspect may be electrically connected with each other. There may be provided a system comprising at least one terminal of the second aspect configured as a transmit terminal, electrically connected with at least one other terminal of the second aspect configured as a receive terminal.

Viewed from a third aspect, there is provided a system comprising a plurality of satellite communications terminals according to the second aspect, each terminal having a digital waveform port, wherein:
the terminals are electrically interconnected;
one of the terminals is provided with a modem and designated as a primary terminal;
the remaining terminals are designated as secondary terminals and connected to the primary terminal in a tree or cascade manner to accept transmit signals and/or to provide receive signals; and
the primary terminal is configured to combine the signals from the secondary terminals such that the plurality of terminals operate together as a single effective terminal.

The plurality of terminals may be rigidly mounted to a common mounting frame.

The terminals may be substantially coplanar or mounted in a substantially coplanar configuration.

Viewed from a fourth aspect, there is provided a method of operating the antenna array according to the first aspect, or the terminal according to the second aspect, or the system according to the third aspect, wherein:
i) the radiating elements are selectively activated by control circuitry to generate a beam for transmitting and/or receiving data traffic to/from a satellite by way of a satellite link;
ii) the control circuitry monitors the data traffic and compares instantaneous data traffic against a capacity of the satellite link;
iii) the control circuitry monitors a quality of the satellite link and a power consumption of the antenna array or the terminal or the system; and
iv) the control circuitry dynamically increases or decreases a number of activated radiating elements in optimize performance efficiency.

Viewed from a fifth aspect, there is provided a method of operating a multi-beam, multi-link satellite communications terminal, comprising:
i) establishing a first link between the terminal and a first satellite by way of a first beam from the terminal;
ii) unlocking a second beam from the terminal by way of a software key, the second beam being directed differently from the first beam;
iii) establishing a second link between the terminal and a second satellite so as to enable increased throughput to the terminal.

Viewed from a sixth aspect, there is provided a method of operating a multi-beam satellite communications terminal, comprising:
i) establishing a link between the terminal and a satellite by way of a first beam from the terminal;
ii) generating a second beam from the terminal and steering the second beam independently of the first beam;
iii) performing at least one of sky mapping, blockage detection, signals intelligence processing, positioning-navigation-timing, interference detection and mitigation by way of the second beam while maintaining the link by way of the first beam.

Embodiments of the present disclosure may be configured to enable full duplex connections to multiple satellites from a single terminal by way of independently steerable beams that allow both transmit and receive.

### BRIEF DESCRIPTION OF THE DRAWINGS

Embodiments of the invention are further described hereinafter with reference to the accompanying drawings, in which:

FIG. 1(a) shows a side view of an improved VSAT communications terminal comprising an array antenna aperture with radome, housing, thermal management system, platform mounting hardware, and multi-purpose expansion bays;

FIG. 1(b) shows a bottom view of the terminal of FIG. 1(a);

FIG. 1(c) shows a top view of the terminal of FIG. 1(a) with the radome removed;

FIG. 1(d) shows a top view of the terminal of FIG. 1(a) with the radome and antenna modules removed;

FIG. 2 shows the distribution of antenna modules between receive and transmit across the antenna aperture of the terminal of FIG. 1;

FIGS. 3(a) to 3(c) show three embodiments of the terminal with different arrangements of internal printed circuit boards;

FIGS. 4(a) to 4(d) show details of a single antenna module holding three lenses with symmetrical rotation of the three lenses within the antenna module;

FIGS. 5(a) to 5(d) show details of a single antenna module holding three lenses with asymmetric rotation of the three lenses within the antenna module to improve the uniformity of scanning behavior across the field of view;

FIG. 6(a) shows a signal flow diagram of RF and digital waveforms for a transmit antenna module;

FIGS. 6(b) shows a signal flow diagram of RF and digital waveforms for a receive antenna module;

FIG. 7(a) shows a single aperture terminal configuration;

FIG. 7(b) shows a dual aperture terminal configuration with a single modem;

FIG. 7(c) shows a dual aperture terminal configuration with two modems;

FIG. 7(d) shows a quadruple aperture terminal configuration with two modems;

FIGS. 8(a) to 8(c) show how multiple feeds under a lens in a single antenna module can be enabled simultaneously to enable individual lens beamforming at a finer resolution than is allowed from a single feed by itself; and

FIG. 9 is a block diagram of the improved VSAT communications terminal and the electrical/signal, mechanical, and thermal interfaces within the system.

### DETAILED DESCRIPTION

Some embodiments of the present disclosure provide a very small aperture terminal (VSAT) communications terminal comprising an antenna aperture in combination with an integrated controller, at least one bay for an integrated modem, and accompanying housing, radome, heat sink, and mounting framework. The combination of these features into a single package offers benefits against terminals that are composed of an antenna, housing, and radome and separate amplifier, controller, and modem components (as is common for many parabolic reflector-based VSAT terminals). The antenna aperture may be a hybrid analog-digital beamforming phased array, where subarrays of the aperture perform beamforming via analog phase and magnitude shifters. Signals from the set of subarrays may be digitized and combined in the digital domain along with phase, magnitude, and time shifts applied via digital signal processing. A preferred embodiment of the antenna aperture is for the antenna subarrays to be composed of electrically-steerable lens antennas that steer their beams by selection of one or more feeds, forming a focal plane excitation on the focal plane of the lens, from a collection of feeds. The lenses may be as described in US 2018/0183152 and U.S. Pat. No. 10,553,947 (the full disclosures of which are incorporated herein by reference), such as an inhomogeneous gradient-index lens, flattened or ordinary Luneburg lens, or metamaterial lens. The location of the focal plane excitation relative to the focal point of each individual lens may determine the scanning angle of the radiation pattern from the individual lens. The feeds at the appropriate position underneath all of the lenses jointly are enabled to create electrically-steered element patterns in all of the subarrays that point in the desired overall pointing direction.

For an individual lens, the minimum spacing between feeds that is dictated by the size and mutual coupling of the feeds means that there are some required scan directions where no one feed can generate a beam in the desired direction. There is the option of picking the feed that generates the beam in the closest direction to the target, but this can result in significant performance degradations, such as the case when the desired focal plane excitation is equidistant from multiple feeds. In this case, multiple feeds may be enabled underneath a single lens simultaneously and their signals summed with magnitude and phase offsets to interfere constructively in the desired direction of operation. This method may enable nearly continuous resolution of element pattern scan directions from the subarrays, rather than the discrete scanning angles achieved by switching only a single feed per lens at a time.

Lens antennas are particularly beneficial when used to form the antenna subarrays, because a lens antenna is very strong in a multibeam context. Generating multiple independent beams from a single lens antenna is performed by enabling multiple feeds simultaneously with different signals. For beams steered in different directions, completely separate feeds may be used, which minimizes the performance impact of generating multiple beams compared to conventional phased array antennas. When multiple beams are pointed close together (where close can be typically defined as within a single beamwidth of the element pattern), then an individual feed may be required to contribute optimally to multiple beams. In this case, the feeds can either be divided to continue contributing only to one beam and allow the beam shape or gain of the other beam to be decreased, or to contribute to both beams simultaneously after backing off the power level of both individual beams. In the expected use cases, beams are typically far apart from each other, such as during handover between a rising and setting satellite, or when communicating with both a geosynchronous equatorial orbit (GEO) and non-geostationary orbit (NGSO) satellite, and the case of sharing power from a single feed between multiple beams is rare and of short duration in each occurrence.

Individual antenna subarrays may be receive-only, transmit-only, or combined receive-transmit in either full- or half-duplex modes. Separating receive and transmit reduces the filtering requirements at the front-end due to the increased isolation between receive and transmit from not collocating those two functions. Reduced front-end filtering requirements may also reduce or minimize absorptive losses in the front end, which may directly impact the critical transmit equivalent isotropic radiated power (EIRP) and receive gain to noise temperature (G/T) metrics.

Independent of the size of the subarrays for beamforming purposes, one or more subarrays may be grouped for convenience in printed circuit board (PCB) design and layout, or sharing control circuitry such as microcontrollers for setting the state of the radio frequency (RF) components. Some preferred embodiments may gather lenses into groups of three to be mounted together and share common circuitry, but other numbers are possible, such as individual lenses, two, four, or six. The number in each group may be selected to enable tiling of the group of lenses. These groups of lenses, together with the associated printed circuit boards with feeds & associated RF front-end circuits and control circuitry, are collectively referred to as antenna modules.

The size of the analog subarrays may be selected based on the competing trades of instantaneous bandwidth, power consumption, and terminal cost. Subarray size may be limited by beam squint, which is a change in the direction of the steered subarray element pattern with frequency that is caused by the frequency dispersion of analog phase shifters. The larger the subarray when measured in electrical wavelengths at the operational frequency of the terminal, the more beam squint will occur. For a hybrid analog-digital array, the ultimate array steering direction is determined by the digital time delay offsets applied by the digital signal processor (DSP), and beam squint exhibits at the system level as a frequency dependence on antenna gain caused by an effective change in gain at the element patterns due to the change in steering direction. In some preferred embodiments, a single lens antenna may used as the subarray to minimize effect of beam squint, but additional lenses may be combined in the analog domain to reduce the number of required DSP channels, which reduces both power consumption and number of integrated circuits (ICs) and therefore cost. Three lenses would be a natural increase, such that a single tri-lens antenna module may be treated as a subarray, or nine lenses consisting of three tri-lens antenna modules.

It is most beneficial for one or more subarrays to be grouped onto a single antenna module, rather than multiple antenna modules to be grouped into a subarray, since all signals at the subarray level are combined in the analog domain and processing introduces noise and distortion. Once the subarray is processed into the digital domain, the data may be transferred and operated upon with much more controlled operations to minimize any further introduced distortions and noise.

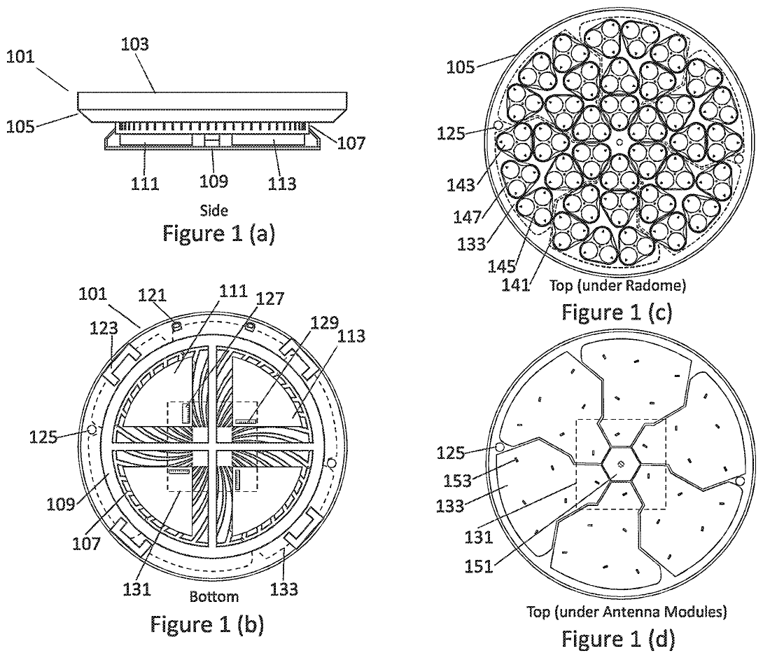

Turning to the figures, in FIG. 1(a), an external side view of a VSAT communications terminal 101 of the present disclosure is shown. The external features of the terminal include a fabric Kevlar-PTFE composite radome 103 stretched tightly across the top of a housing 105, which serve for environmental protection. A combination heat sink 107 serves as the structural core of the terminal to which both the internal and external components are fixed, and is structured to support the mass of the terminal under the expected vibrational and torsional loads in operation while also dissipating the heat generated from the internal electronic components. The terminal is connected to the base platform (which might include a land vehicle, maritime vessel, aircraft, or fixed building) by a mounting frame 109, which can take multiple forms depending on the specific platform. Mounted to the underside of the heat sink 107 are the modular power supply bay 111 and the three modular multi-purpose bays 113, which support installation of modems and other hardware to expand the functionality and features of the terminal by the end-user. The modular multi-purpose bays 113 are configured to facilitate field replacement of hardware modules in the terminal 101. For example, an analog modem may be swapped for a digital modem depending on requirements, or an empty bay 113 may be used to supplement an existing analog modem with a digital modem, and control circuitry may allow switching between the analog modem and the digital modem as required.

As seen in the bottom view of FIG. 1(b), the preferred embodiment of the terminal is circular to facilitate the uniformity of radiation patterns as well as the construction and mounting of the fabric radome 103, but other shapes such as hexagonal, octagonal, square, and rectangular are also possible to support specific platform requirements.

The power supply bay 111 and multi-purpose bays 113 are shown superimposed upon the central control module (CCM) 131 on the other side of the heat sink 107, with connectors 127, 129 passing through the heat sink 107 to provide power and signal connections to the contents of the bays 111, 113. The external user interface (including management & user data ethernet & serial ports, Tx mute, and status readouts) is available through the modular power bay 111, which may be replaced to change a terminal from a DC supply (such as a nominal 24V vehicular supply) to an AC supply (such as a 120 or 240 VAC mains supply). Silhouettes of the global navigation satellite system (GNSS) receiver antennas 125 and parallel combiner slice (PCS) PCBs 133 within the terminal are also illustrated. Additional features may include crane or hoist attachment points 121 and carrying handles 123.

The top of the terminal 101 with the radome removed is illustrated in FIG. 1(c). This shows the antenna aperture composed of a collection of antenna modules 141 tiled in a circular arrangement, with each lens module 141 consisting of three lens antennas 143 mounted by a structural frame 147 in a triangle. In this example embodiment, the antenna modules 141 are mounted to the underlying PCS 133 via a connector 145 to carry signals and power. FIG. 1(d) illustrates the PCS boards 133 after removing the antenna modules 141. The arrangement of the antenna modules 141 are selected to have 6-way rotational symmetry to enable the same PCS board 133 design to be tiled symmetrically around the terminal. Symmetry is not required, but yields simpler design and lower costs by increasing manufacturing volumes for each individual PCB. The six-way rotational symmetry shown in FIG. 1(c) can be changed for different aperture sizes to N-way rotational symmetry, but optimally uses rotational and/or reflectional symmetry of order greater than N=5 for producing a better approximation to a uniform circular distribution of antenna modules 141. The symmetry selected can also be affected by the diameter of the terminal and the packing efficiency of the PCS PCB into common PCB fabrication batch sizes. Larger apertures may require splitting into more pieces, or even splitting the PCS 133 as shown into multiple pieces and manufacturing as separate PCBs before attaching via connectors. The number of board-board connectors should be minimized, however, for cost, reliability, and performance reasons.

The PCS 133 is irregularly shaped to accommodate the tilings of the triangular antenna modules 141 while still achieving an optimal packing density. In this embodiment, each PCS 133 hosts six antenna modules 141, of which three antenna modules 141 are configured to operate in the transmit mode, and three in the receive mode. Different aperture sizes can be configured with more or fewer antenna modules 141 and different ratios between receive and transmit modules to vary the performance ratio between receive and transmit at the terminal level. The GNSS antennas 125 may be electrically connected to the PCS 133 or directly to the CCM 131 and mounted to the housing 105. Depending on the implementation, the signals passed from the antenna modules 141 to the PCS 133 via the connectors 145, 153 may either be digital (if the DSP ICs are mounted on the antenna module 141) or analog (if the DSP ICs are mounted on the PCS 133). An additional PCB 151 connects the six PCS 133 to share common signals and power, and each PCS 133 connects down to the CCM 131 for unique connections to each PCS 133 such as the control and high-speed digital waveform lines.

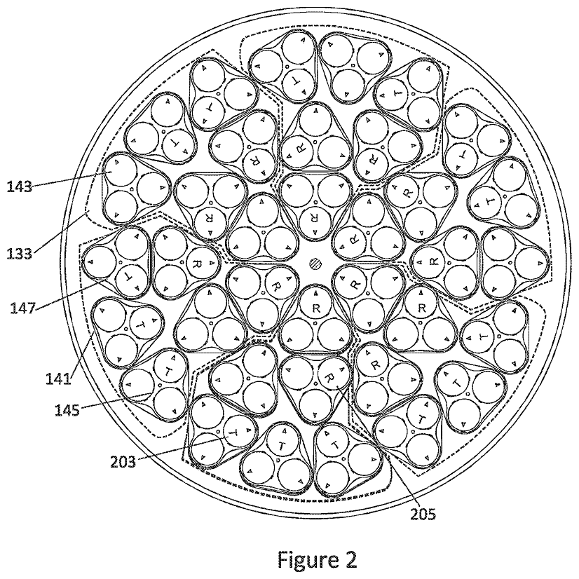

More detail of the arrangement and distribution of the receive and transmit antenna modules 141 in a preferred embodiment are shown in FIG. 2. Here, the modules 141 are marked with a T or an R to indicate Transmit antenna module 203 or Receive antenna module 205, respectively. The collection of transmit antenna modules 203 can be referred to as the transmit subarray, and the collection of receive antenna modules 205 can be referred to as the receive subarray. The transmit subarray forms an annular ring around the outside of the terminal 101, while the receive subarray forms a circle in the center of the terminal 101. The transmit and receive antenna modules 203, 205 should optimally form individually contiguous regions, without interspersing transmit and receive antenna modules 203, 205 freely. The average spacing between modules in the transmit or receive subarray contribute to the quality of the beamforming and the sidelobe level of the overall array antenna.

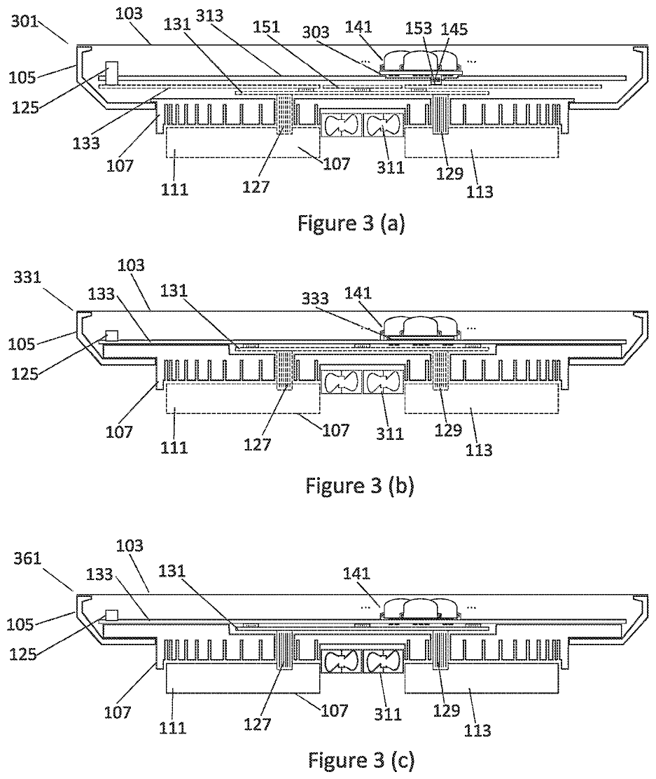

Multiple potential embodiments are illustrated in FIG. 3(a)-(c). FIG. 3(a) shows the standard embodiment 301, where each antenna module 141 has its own PCB 303 upon which are mounted the feeds for the lens antenna 143 and the accompanying front-end RF circuits (including amplifiers, control, etc.). The PCB 303 is then connected through the supporting array plate 313 to the respective PCS 133 through the connectors 145, 153. The array plate provides structural support and stiffness to the design for vibration resilience, and also serves as a direct thermal path for removing heat from the RF front-end ICs on the PCBs 303 and conducting it through heat pipes and other connections to the heat sink 107.

The PCS 133 is shown connecting to the CCM 131, which also connects to the power bay 111 and multi-purpose bays 113 using the connectors 127, 129 through slots in the heat sink 107. Depending on the expected levels of dissipated power and operating temperature ranges, fans 311 may be included to provide forced-air cooling across the heat sink.

This embodiment 301 is the simplest to design, as it separates the functionality of the antenna modules 141, which provide the front-end RF processing from multiple lens antennas 143 and associated feeds, from the PCS 133, which combine signals from multiple antenna modules 141, from the CCM 131, which performs the ultimate beamforming operation to combine the signals from all of the PCS 133, and hosts the terminal control and management processors and software.

A modified embodiment 331 illustrated in FIG. 3(b) reduces the number of connectors in the design by removing the connectors 153, 145 between the antenna modules 141 and the PCS 133. All of the circuitry formerly mounted to the PCB 303 is then mounted to the PCS 133, and the feed antennas excited through ball grid array (BGA) or land grid array (LGA) solder bumps connecting the modified surface mount technology (SMT) PCB 333 within each antenna module 141 to the respective PCS 133. This embodiment reduces the cost and losses of the connectors and compresses more circuitry and functionality into the PCS 133.

A further simplification 361 illustrated in FIG. 3(c) removes the SMT PCB 333 and instead places all of the feeds for all lenses directly onto the PCS 133. This reduces the number of PCBs in the system overall and reduces assembly costs by not requiring attachment of the SMT PCB 333 to the PCS 133, but requires a very high component and trace density on the PCS 133.

In embodiments 331 and 361, the array plate 313 is no longer required, since the thermally active components are now directly mounted to the PCS 133. In these embodiments 331 and 361, the array plate 313 the plate is removed (which offers a mass reduction for the terminal as a whole) and the structure of the heat sink 107 adjusted to directly remove heat from the circuits mounted to the PCS 131.

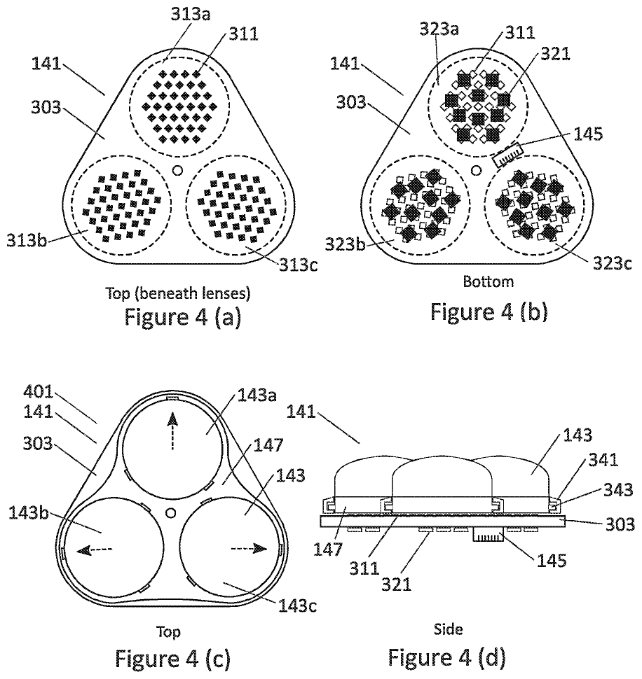

Details of the preferred embodiment for the antenna module 141 are illustrated in FIG. 4(a)-(c). FIG. 4(a) illustrates the top view of the PCB 303 of the antenna module 141 (after removing the lenses 143 and mounting hardware 147), showing the feeds 311 gathered into feed groups 313a, 313b, 313c associated with the three lenses of the antenna module 141. The feed groups 313a, 313b, 313c or radiators are shown as rotated symmetrically about the center of the module 141, such that the position of the feeds 311 do not overlap exactly between the three lenses 143 in the antenna module 141. The example embodiment shows 3-fold symmetry, but different numbers of feed groups can be included and the design extended to M-fold symmetry of the feed groups. In some cases, a slight asymmetry in the angles of the different clusters can be advantageous, rather than exact M-fold symmetry. This contributes to producing a smooth scanning profile at the array level together with the rotation of the antenna modules 141 themselves relative to the array as a whole, as when a desired beam location would not overlap exactly with any particular single feed 311 in one lens 143, a different feed 311 in a different lens 143 is likely to be closer, helping to fill in the gap between the beam patterns of the discrete array of feeds 311 beneath each lens 143.

FIG. 4(b) shows a bottom view of the PCB 303 and the antenna module 141, showing the front-end RF ICs 321 associated with the feeds 311 shown as silhouettes. The RF ICs 321 are also divided into groups 323a, 323b, 323c associated with the three lenses 143a, 143b, 143c in the antenna module 141. The front-end RF ICs provide low noise amplifiers (LNAs) and phase/magnitude shifters in the case of receive antenna modules, and high power amplifiers (HPAs) and phase/magnitude shifters in the case of transmit antenna modules, as well as polarization control for each feed. In the preferred embodiment, up to four feeds may be driven by a single RF IC 321, depending on the arrangement of feeds. It is preferable for the distance from a feed 311 to the RF IC to be as short as possible to minimize the signal losses between the feed 311; using fewer than the full number of channels available on a given RF IC 321 may be preferable to utilizing all channels but routing a signal over a long distance.

FIG. 4(c) and FIG. 4(d) shows a top view and side view, respectively, of an antenna module 141, and illustrates the mounting structure 147, 341 that engages with mounting features 343 or lugs integrated into the lenses 143 to hold the lenses to the PCB 303 to form the antenna module 141. The mounting structure 147, constructed of polymer materials for cost, is designed to have slots or grooves to engage with the base of the lenses 143 to constrain their location within required lateral (in the plane of the PCB 303) and tangential (distance from the PCB 303) tolerances relative to the PCB 303. The lugs 343 or other features included in the lenses 143 serve to provide structural supports for engagement with matching structures 341 on the mounting structure 147.

Although FIG. 4(a)-(d) illustrate the configuration for embodiment 301 of the terminal 101, similar configurations are used in embodiments 331, 361, and are not shown.

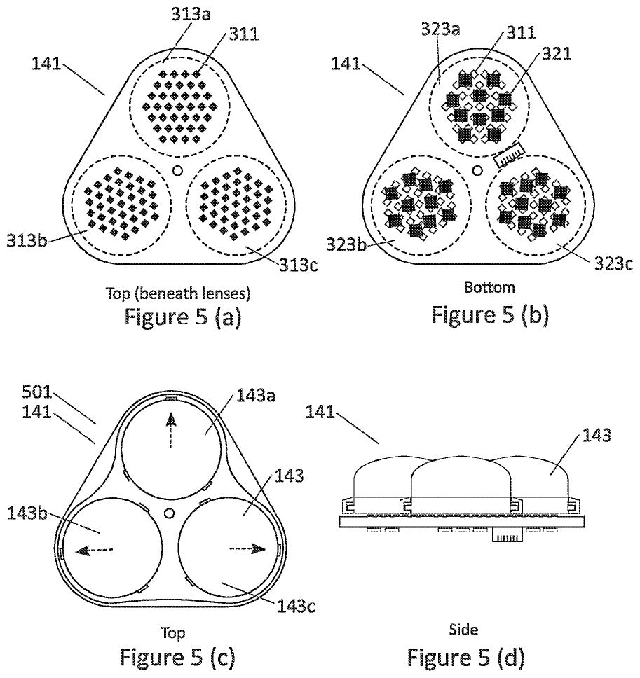

FIG. 5(a)-(d) show an alternate embodiment 501 of the antenna module 141 with the same features and elements as shown in FIG. 4(a)-(d) 401, but illustrate an alternate orientation of the three lenses 143 relative to the center of the antenna module 141. Where the module 401 shown in FIG. 4(a)-(d) shows the lenses and associated feeds tiled symmetrically at a 120 degree angle around the center of the module 141, the alternate embodiment 501 changes the angle of the lenses 143 to be asymmetric. An asymmetric arrangement of the lenses 143 as shown in FIG. 5(a)-(d) can further improve the beamforming from the array. Increased symmetry is preferable for design, manufacturing, and installation, but decreased symmetry allows average sidelobes to be reduced and uniformity of beam quality across the scan volume to be improved.

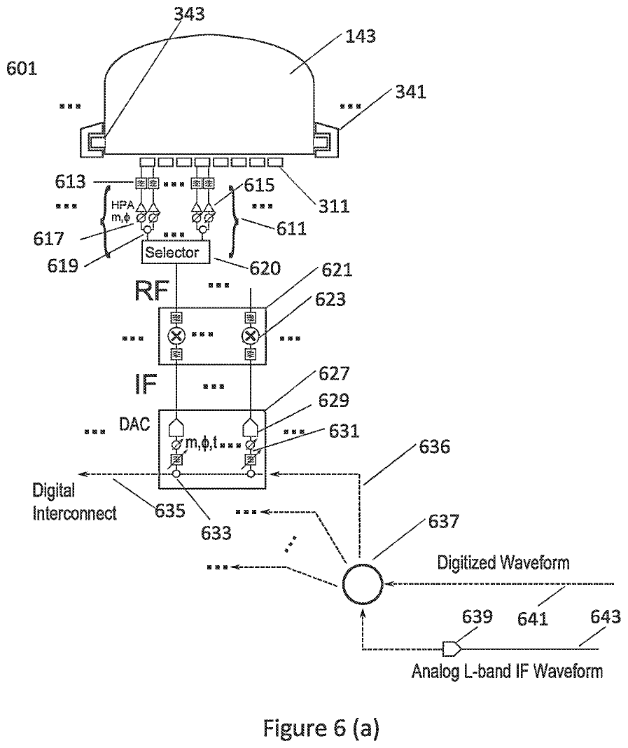

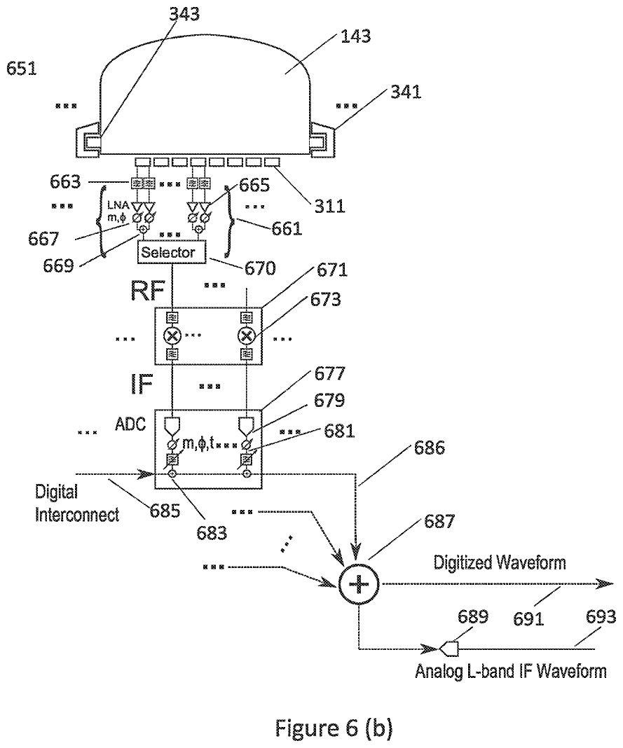

FIG. 6(a) demonstrates the signals throughout the antenna for the transmit subarray 601. Starting from the bottom, a waveform is sourced from the modem either as a digitized waveform 641 directly, or as an analog L-band IF signal 643 that is digitized in preparation for use with the transmit subarray by the analog-to-digital converter 639. The digitized waveform 641 uses one of the accepted RF over ethernet protocols, such as VITA-49 or eCPRI, to transfer waveform samples in a structured and real-time fashion. The physical link 641 to the modem may use gigabit ethernet for low-bandwidth signals, but more commonly a 10-gigabit ethernet link with either copper or fiber physical layer, or even a 40-gigabit fiber for very high bandwidth signals. The digitized waveform in either case is split 637 between multiple independent paths, typically one for each PCS 133. The splitter 637 and associated hardware such as the analog-to-digital converter (ADC) 639 may be implemented jointly on a field-programmable gate array (FPGA) or system-on-chip (SOC).

Each of the split data streams 636 are then passed through a daisy chain of DSP stages 627, which cascade the digitized waveform 636 to additional DSP stages 627 through the digital interconnect 635, while splitting off copies of the signal 633 to be passed through configurable digital filters and time/phase/magnitude shifters 631. The time delay, typically implemented as a configurable buffer in the DSP stage combined with fine-tuning through the configurable filter, allows the physical distance between subarrays to be corrected for and therefore reduce the incidence and impact of beam squint in the array radiation pattern. The final stage of the DSP stage 627 is a digital-to-analog (DAC) converter 629 that produces a baseband or intermediate frequency (IF) analog signal from the processed waveform samples 636. Each stage includes one or more duplicate processing chains to support multiple channels of data to be processed independently, such as separate subarrays, antenna modules 141, lens antennas 143, or multiple beams associated with a single antenna module 141 or lens antenna 143. The DSP stage may be implemented as separate ICs for each stage, or may be implemented by combining multiple stages 627 and the splitter 637 into a single monolithic FPGA or SOC. The number of DSP stages and channels per DSP stage 627 are determined by the number of supported beams per subarray and the number of subarrays in the array 101.

Analog intermediate frequency (IF) signals from the DSP stages 627 are then upconverted to the target RF frequency in a mixer stage 621, which includes multiple mixers 623 and associated filters and other relevant circuitry, such as local oscillator (LO) generation, management, and amplification, clock synchronization, and configurable amplification. Mixer stages 621 may be implemented as integrated ICs, or may be composed of discrete components.

One upconverted RF signal is generated for each supported beam in each subarray of the terminal 101. The RF front-end 611 consists of a selector 620 that chooses one or more feeds 311 within a subarray to use for a given beam. The selector 620 acts as a matrix switch that allows any number of outputs to be connected to each input, as well as summing outputs to receive inputs from multiple inputs simultaneously. Any feeds 311 that are not selected by at least one beam can have their associated amplifier 615 and other circuitry 617 disabled to reduce power consumption. This process then allows an individual feed to contribute to multiple beams, by summing multiple RF inputs. The resulting signal for each feed, which may be disabled individually as necessary, is then split 619 into two components for two polarizations, which are then individually processed via a magnitude and phase shifter 617 and amplifier 615 before being passed through a filter 613 and radiated by the feed 311 through the lens 143, with the direction of the resulting signal being determined by the location of the feed 311 relative to the focal point of the lens 143. The RF front-end 611 circuits can be implemented as an integrated IC with multiple channels per IC, or can be implemented with a combination of discrete components.

Turning to FIG. 6(b), the diagram illustrates the signal flow and circuitry within the receive subarray 651. Starting from the top, a signal from a given satellite will be received by a lens 143 and focused down to a region on the focal plane that intersects one or more feeds 311. The feeds will transduce the received signal into two waveforms, one for each polarization (horizontal & vertical (H & V), or left-hand circular polarization & right-hand circular polarization (LHCP & RHCP)). The two polarization signals are processed separately to allow reconstructing the polarization of the received signal. Each of the two polarization waveforms will be passed through a filter 663 and initial low-noise amplifier 665. In order to maximize the receiver sensitivity, the noise figure (NF) of the LNA should be minimized, and any absorptive losses in the lens, feed, filter, and connecting traces should be minimized. After the amplifier 665, the signals are magnitude and phase shifted 667 and summed together 669 to re-form a single waveform signal corresponding to the respective feed. A selector 670 is then used to switch, split, or combine the signals from multiple feeds into one or more output beam signals for a subarray (such as a single antenna module 141 or lens antenna 143). The selector may be implemented by multiple levels of configurable combiners or switches sufficient to allow selecting from any of the feeds associated with the subarray. Any feeds 311 that are not selected by at least one beam can have their associated amplifiers 665 and other circuitry 667 powered down to reduce unnecessary power consumption.

The output of the selector 670 is then passed to a mixer stage 671, which includes a downconverting mixer 673 and associated filters and other circuits, such as LO generation and management. Multiple channels may be included in the mixer stage 671, to support multiple beams.

The output of the mixer stage 671 in then processed in the DSP stage 677 by first being digitized by the analog to digital converter 679. Each channel corresponding to a beam and subarray is digitized separately and processed with phase, magnitude, and time shifters and reconfigurable filter 681. The output of each digitizing channel in the DSP stage 677 is then summed 683 with the input 685 of the DSP stage 677 to produce the output waveform 686 consisting of the sum of all of the signals of the different subarrays from a single beam of a single PCS 133. The combined waveforms 686 from each beam of each PCS 133 are then summed into a single output waveform for each beam from the terminal 101 as either a digitized waveform 691 or as an analog L-band IF waveform 693 after being passed through a DAC 689. The DSP stages, summer 687, and DAC 689 may be implemented in an integrated FPGA or SOC, or may be implemented with custom components for each stage and function.

A controller, hosted on the CCM 131, which may take the form of one or more microprocessors (potentially hosted on an FPGA or SOC), interacts with all of the components in both the transmit 601 and receive 651 subarrays. The amplifiers 615, 655, phase & magnitude shifters 617, 667, and selectors 620, 670 for different channels in the set of lenses 143 may be enabled/disabled and values configured by the controller. Depending on the number of beams in use at a moment in time, individual channels of the mixer stages 621, 671 and DSP stages 627, 677 may be enabled or disabled. For any enabled channels, the settings of the time, phase, and magnitude shifters and the reconfigurable filters are set by the controller, which will also configure the appropriate LO settings for the mixer stages 621, 671 for each enabled beam. The controller also serves as the antenna control unit (ACU) that enables both inertial and GNSS-based tracking of stationary and moving (GEO & NGSO) satellites from stationary and moving platforms, as well as the external user interface and management system for the terminal. The summer 687 and splitter 638 functionality are implemented on the CCM 131.

The waveforms 641/643, 691/693 are sourced from/provided to a modem connected to the terminal 101. Multiple modems may be connected, to allow for multiple beams to be active from the terminal 101 at once. Modems are connected to the CCM 131, which processes the digitized waveforms 641, 691, through the multi-purpose bays (MPB) 113 and associated connectors 129. The terminal 101 supports different contents of the MPB 113, which can include modems installed in card form directly to integrate the entire functionality of a communications terminal into a single box. In this case, digital or analog waveforms 641, 643/691, 693 are received from/provided to each modem within a MPB 113. Alternately, the MPB 113 can itself include external connectors, such as N-type coax, ethernet, or others, to enable connecting an external modem to the terminal. Since the digitized signals 641, 691 are available, modified or simplified versions of the modem may be used that do not include the typical initial DAC/ADC stages, reducing the power consumption of the modem.

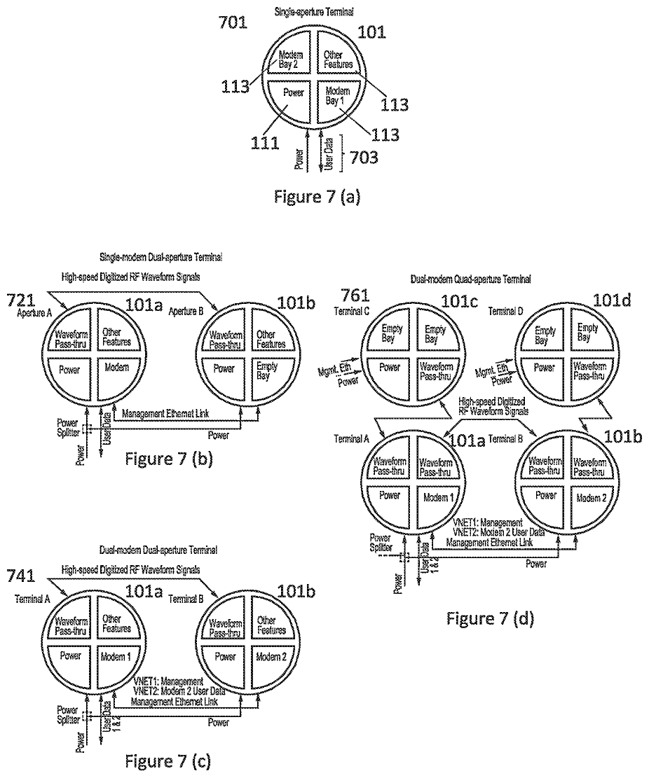

The MPB 113 may be used for other functionality as well, not only modems. Alternate communications channels may be installed, such as additional networking ports, cellular modems for data offloading, or local WiFi. In addition, the digitized waveforms 641, 691 that can be transferred through the MPB 113 can be used to perform beamforming between multiple terminal instances 101, rather than only connect to a modem. Multiple instances of the terminal 101 may be used in different configurations and combinations, as illustrated in FIG. 7(a)-(d). FIG. 7(a) illustrates a representative single-terminal configuration 701 with two of the three multi-purpose bays 113 being used to host modems, and the one remaining bay left empty or used to host other features and functionality. This configuration 701 requires ethernet and power connections as its external user interface 703, and supports up to two simultaneous links to two separate satellites for one supported link per modem.

FIG. 7(b) shows an alternate single-modem dual-aperture terminal 721 composed of two terminals 101a and 101b. In this configuration 721, terminal A 101a hosts the modem in one of the MPB slots 113 (and would thus be designated as the primary terminal), and an additional waveform pass-through card in a second MPB slot. The waveform pass-through enables the waveforms 641,691 to be transferred from a secondary 101b to a primary terminal 101a and combined with the waveforms from 101a to form a combined waveform to be provided to the modem. In effect, the waveforms to/from the second terminal are treated as additional inputs/outputs from the splitter 637 and summer 687 by the CCU 131 of the primary terminal 101a. In this way, the signal architecture from FIG. 6(a)-(b) is shown to support combining signals from multiple terminals, as well as from multiple beams and PCS 133. The effects of combining 721 two terminals 101 is that the performance of the combined terminal 721 is greater than the two individual terminals. A single beam is steered from each of the two terminals and pointed in the same direction, and digital beamforming used to combine the resulting terminals to create a combined signal. With sufficient calibration and coordination between the relative position & orientations of the terminals 101a and 101b, the receive and transmitted waves can be coherently combined to produce a in effect a single terminal composed of the two sub-terminals with greater performance. The receive performance can increase by up to 3 dB (because antenna gain increases with the doubled aperture area), and the transmit link by up to 6 dB (because antenna gain increases with the doubled aperture area, and the radiated power doubles with the increased number of amplifiers). Calibration challenges with the transmit link will limit the achieved performance increase, so less than the full 6 dB increase for two terminals would be expected. With a sufficient calibration process, the two constituent terminals 101a and 101b of the combined terminal 721 may be coplanar and closely positioned so as to be in contact, or arbitrarily placed. Calibration will be more successful with better results for the transmit functionality when the terminals are closely positioned and rigidly mounted with respect to the other.

FIG. 7(c) illustrates a dual-modem dual-terminal configuration 741. This can be regarded as a derivation of the single-modem dual-terminal configuration 721, in that a second modem is added to support a second beam from the combined terminal 741. As one potential implementation, the second modem is installed in the secondary terminal 101b, with the waveform data from 101a being transferred to 101b for the second beam while the waveform data from 101b is transferred to 101a for the first beam, and processed in each case by the respective splitter 637 and summer 687 in each terminal 101.

FIG. 7(d) illustrates a dual-modem quad-terminal configuration 761. This can be regarded as a derivation of the dual-modem dual-terminal configuration 741, by filling the unused MPB 113 in each terminal 101a and 101b with an additional waveform pass-through card to establish the connection to an additional terminal each, 101c and 101d. There is no restriction on the number of terminals that can be combined in this manner. In addition to implementing the interconnect between terminals 101 via the MPB 113, an external combiner module with the same functionality could be used to combine two or more terminals 101 in to a combined terminal.

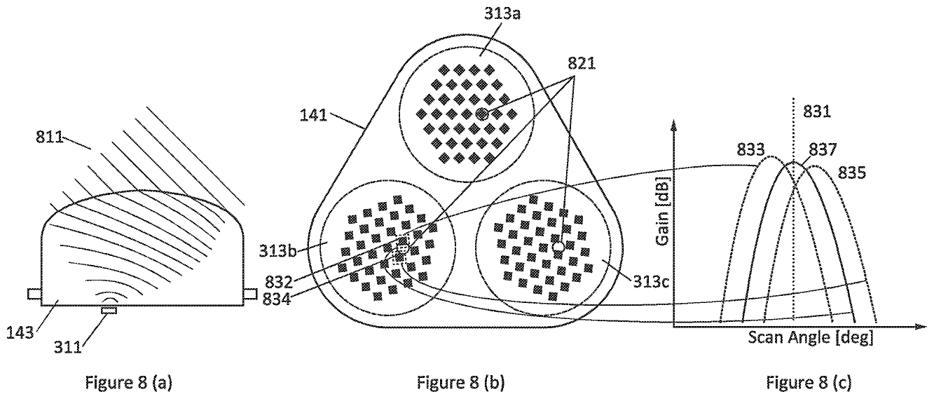

Due to the difference in orientation between lenses and feeds within a single antenna module 141, some special handling is required to enable beamforming across the array. FIG. 8(a) illustrates the behavior of a single lens antenna 143, which at the simplest level converts a roughly spherical wavefront emanating from a feed 311 into a plane wave in a direction determined by the relative location within the focal plane of the feed 311 from the focal point of the lens 143. In order to steer the beam of the lens antenna in a desired direction, a particular position exists on the focal plane where a feed would be required. However, as illustrated in FIG. 8(b), the arrangement of the feed groups 313a, 313b, 313c means that the desired feed location 821 (illustrated as circles) under the lenses to generate a desired beam direction 831 does not necessarily align with the actual locations of the feeds in some or all of the lenses. In effect, this is the challenge with any switched-feed antennas to achieve continuous rather than discrete scanning of a beam—changing active feeds between discrete options changes the resulting scanned beam by discrete angles.

There are multiple ways that that this can be managed for the terminal 101 overall. The simplest case is to choose the single closest feed under each lens for the desired beam direction 831, and accept that most lenses will produce element patterns that are not peaked in the desired scanning direction, thus reducing the overall array antenna gain in the desired direction. This is illustrated in FIG. 8(b) and FIG. 8(c) by feed group 313b. The desired feed location 821 is not aligned with a single feed, but is located between feeds 832 and 834. Feed 832 is the closest to the desired location 821; when enabled, it produces beam 833, which is not centered on the desired scanning angle 831. If the array is operated in this way, then the lens associated with feed group 313a will produce nearly full performance since the desired feed location is centered on a feed, but the lenses associated with feed groups 313b and 313c will contribute less gain to the array due to their element patterns being reduced.

By enabling multiple feeds at once beneath a single lens, as shown in feed group 313b for feeds 832 and 834 with an appropriate calibrated magnitude and phase difference, an aggregate element pattern 837 from the lens can be produced as the weighted sum of the two feed patterns 833 and 835 to point in the desired beam steering direction 831. When this process is repeated for all of the lenses 143 in the terminal 101, the improved performance over enabling only the closest feed 311 in each lens can be significant. Additional feeds can be enabled using the same principle, with diminishing returns on improved performance for enabling more than about four feeds in most configurations. The results are even more significant in transmit mode than receive mode, since each enabled feed contributes RF power as well as improved antenna radiation patterns, thus contributing to the transmit EIRP in two ways. Which feeds and the number of feeds under each lens for a given beam are configured by the selector 620, 670 hardware by the controller on the CCM 131.

The number of feeds used under each lens for beamforming can be adjusted to tune the performance of the array. For example, in a power-optimized operational mode, the controller might select only a single feed 311 per lens 143 and accept the reduction in performance. Alternately, the controller might select four feeds 311 per lens 143 in a performance-optimized operational mode, in exchange for increased power consumption and heat generation. Different operational modes can be applied to different beams, such that a standby beam might be dynamically configured to use minimum resources (feeds, power) in a standby mode, but to automatically scale up to more resources if the link becomes busy. Intermediate and intelligent steps can be applied as well, with varying number of feeds selected per lens based on a balance of power and performance, such as only adding an additional feed if it increases the per-lens performance by a set threshold, or enabling more feeds per lens at wide scanning angles where scan losses are more severe, but operating with reduced number of feeds near boresight where gain is improved. These forms of dynamic resource allocation allow the performance and power consumption of the terminal 101 to be adjusted under software control as circumstances demand. The use of different numbers of feeds as different performance modes is a commercially valuable feature, as access to different settings can be included as software-unlocked capabilities for end-users. For example, a terminal operates ordinarily in a standard power setting with a given set of specified performance metrics. An end user, through the controller or a web interface, could request additional features, including additional beams past a default of one, to be unlocked either in an unlimited or time-limited way through a software key. The ability to boost satellite link performance by a discrete amount for a period of time could allow for more performance while traveling in a location with poor coverage to a desired satellite, or to support additional users or visitors during a short time period when the additional communication capacity is not required all of the time.

The number of feeds may be set by the controller in all cases. For each beam and lens, one or more feeds may be enabled to create the beam. The controller, by monitoring the link performance (such as the carrier to noise ratio) and the requested data traffic (instantaneous throughput, buffer lengths, TCP retransmits), can change the number of enabled feeds to better match the antenna's performance to the capacity of the link. By decreasing the number of feeds when traffic is low, power is saved. When traffic is high and the link is congested, additional feeds can be enabled to increase the EIRP & G/T of the multibeam lens array terminal and improve the communications performance, at the expense of increased power. This dynamic resource allocation feature allows power consumption and performance to be balanced by changing the number of enabled feeds under each lens for each beam.

The number of enabled feeds may also affect the beam quality. Enabling multiple feeds can improve the shape of the radiation patterns of a lens antenna even if all but one feed are enabled with significantly lower signal amplitude by being tuned to compensate for sidelobes or beam asymmetry from the dominant feed.

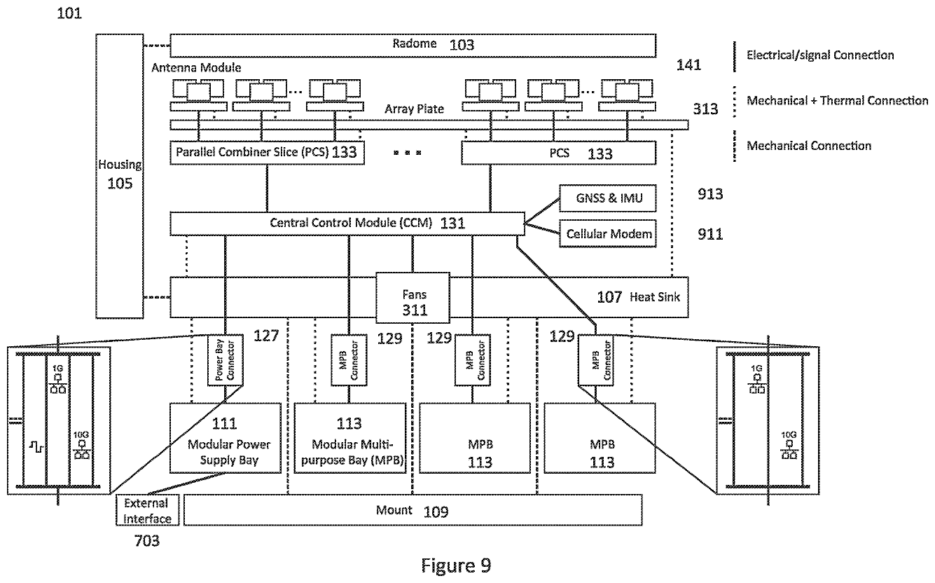

A block diagram of the critical components of the terminal 101 is shown in FIG. 9. The diagram illustrates with different connection types the key mechanical, thermal and electrical connections between blocks. The heat sink 107 forms the thermal and structural foundation of the terminal, to which all of the other components are attached. The housing 105 around the perimeter of the terminal 101 serves primarily as environmental protection, and to support the fabric radome 103, which is required to be tensioned in order to maintain operation. The terminal 101 is installed to a platform through a platform-specific mount 109 that adapts to the mounting features included on the heat sink 107.

The heat sink 107 is thermally connected, directly and indirectly, to all of the heat-generating electronic components in the system. The subsystems with the highest power density are the transmit antenna modules 141, which hold the final-stage high-power amplifiers. In this embodiment, the antenna modules 141 and the PCS 133 are mounted on both sides of an array plate 313, which acts as both structural support as well as a local heat sink for the high-power RF & digital components. The array plate 313 may be implemented as a machined or cast aluminum plate with cutouts to interface with the circuits and components, or may include heat pipes to increase thermal conductivity. In the case of embodiments 331 or 361, the array plate 313 may be removed and compensated by a more direct thermal connection directly from the heat sink 107. The array plate 313 then connects via heat pipes or other thermally conductive structures to the heat sink to transfer the heat from the circuitry to the base of the terminal 101, where the heat may be radiated from the heat sink 107 assisted where required by forced air provided by the fans 311.

RF signals received/transmitted from the antenna modules 141 are provided to/from the PCS 133 as either analog RF or IF or digital waveforms, with the mixer stage 621, 671 and DSP stage 627, 677 functionality implemented either within the antenna module 141, the PCS 133, or CCM 131. The waveforms are transferred between the various PCS 133 and CCM 131, where the signals from all of the PCS 133 are combined. The controller on the CCM 131 also controls and sets of the state of all of the electrical components of the system and configures the communications path between the MPB 113 and the CCM 131. The controller on the CCM 131 is connected to the GNSS & inertial measurement unit (IMU) sensors 913 and the optional integrated cellular modem 911 to provide either low-cost backhaul when in range of terrestrial communications coverage and back-channel terminal debugging and updates through low-bandwidth terrestrial links.

The MPB 113 is mounted to the heat sink 107 with the connector 129 passing through a slot. The contents of the MPB 113 (which may be an embedded modem card, an external modem pass-through card, a digital waveform pass-through card, or other functionality) communicate with the controller on the CCM 131 to pass power, control, management, and waveform data through the connector 129. The connector passes control, management, and user data through gigabit ethernet, digitized waveform samples through gigabit, 10-gigabit, or greater ethernet, power, and any incidental signals required by modems or other devices (such as Tx mute). The modular power supply bay 111 is also mounted to the heat sink 107 with the connector 127 passing through a slot. The connector 127 includes regulated power supply to the terminal 101, ethernet connections to support the external user interface as well as management and control and user data forwarded from internally installed modems, as well as other individuals signals such as serial ports and Tx mute lines. The modular power supply bay 111 and MPB 113 are field removable and swappable. The external user interface, including management and user data ethernet ports, indicators, and the external power supply input are provided from the modular power supply bay 111.

With multiple modems installed (or a multi-beam capable modem), the terminal 101 can support multiple independently-steerable bidirectional beams (where each beam is a transmit-receive pair) where the pointing angle in two dimensions (theta, phi or azimuth, elevation) of each of the beams is set by the antenna controller. These beams can be used for multiple links to multiple satellites in different constellations or orbits, for make-before-break handovers where the current satellite can be changed without losing the link.

There are additional use cases and commercial values for the second and further beams of the multibeam satcom terminal. In some cases, such as handover, the use of the second or further beams could be enabled and available all of the time. In other circumstances, the end user may only require a single link at most times. However, if during a short time they required additional bandwidth, the satellite service provider in concert with the antenna hardware vendor could offer access to additional beams as a service to temporarily (or permanently) increase the capacity to a single terminal. In this way, end users with requirements for single links can have access to the other capabilities of the electrically-steered terminal at a lower cost, while end-users making full use of the many-beam connectivity to establish multiple bidirectional links can access the capability of the terminal through a software unlock. In other cases, the end users of the terminal might not know or care about how many beams are used to provide the contracted bandwidth, and a service provider or satellite operator might transparently enable or disable different beams to different satellite assets in order to optimize the efficiency and/or throughput of their network. In either case, the terminals capability to establish multiple links with multiple satellites opens new options for commercializing the capability.

Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A multi-beam antenna array, comprising:
a main array of antenna modules, each antenna module comprising a plurality M of individually-steerable antenna elements;
wherein the antenna modules are arranged in the main array with N-fold rotational symmetry;
wherein the antenna elements are arranged within each module with M-fold rotational symmetry; and
wherein each antenna element comprises a sub-array of radiating elements.

2. The antenna array according to claim 1, wherein each antenna module comprises at least three individually-steerable antenna elements.

3-4. (canceled)

5. The antenna array according to claim 1, wherein the antenna modules have a circular or regular polygonal arrangement.

6. The antenna array according to claim 1, wherein the antenna modules are arranged in a plurality of nested, substantially concentric circles or regular polygons.

7. The antenna array according to claim 1, wherein some of the antenna modules are configured as transmit antenna modules and a remainder of the antenna modules are configured as receive antenna modules.

8. The antenna array according to claim 7, wherein some of the antenna modules are configured as transmit antenna modules and a remainder of the antenna modules are configured as receive antenna modules, and wherein each substantially concentric circle or polygon comprises only transmit antenna modules or only receive antenna modules.

9. The antenna array according to claim 8, wherein an outermost circle or polygon comprises transmit antenna modules, and wherein an innermost circle or polygon comprises receive antenna modules.

10. The antenna array according to claim 1, wherein the antenna modules are mounted on a substrate.

11. (canceled)

12. The antenna array according to claim 10, wherein the substrate comprises a plurality N of tiled sections.

13. The antenna array according to claim 12, wherein each of the N tiled sections of substrate has a substantially identical arrangement of antenna modules mounted thereon.

14. The antenna array according to claim 1, configured such that beams formed by the individually-steerable antenna elements are steered in an analog domain.

15. The antenna array according to claim 14, configured such that a beam formed by combining the beams formed by the individually-steerable antenna elements is steered in a digital domain.

16. The antenna array according to claim 1, wherein the sub-arrays of radiating elements are configured as evenly-spaced feeds in a circular or regular polygonal grid arrangement.

17. The antenna array according to claim 16, wherein the radiating elements in the sub-arrays are arranged so as to display M-fold rotational symmetry together with the antenna elements within each module.

18. The antenna array according to claim 16, wherein the radiating elements in the sub-arrays are arranged so as to not to display M-fold rotational symmetry together with the antenna elements within each module.

19. The antenna array according to claim 1, wherein the sub-arrays of radiating elements are configured as non-evenly-spaced feeds.

20. The antenna array according to claim 1, wherein each individually-steerable antenna element is a lens antenna comprising a dielectric lens.

21. The antenna array according to claim 10, wherein the radiating elements in each sub-array are mounted on a printed circuit board (PCB) that connects to the substrate via a connector.

22.-24. (canceled)

25. The antenna array according to claim 10, wherein the radiating elements in each sub-array are mounted on the substrate.

26. The antenna array according to claim 25, further comprising front-end RF circuits or amplifiers that are mounted on the substrate.

27. The antenna array according to claim 1, wherein there is one mixer stage channel and one digital signal processor (DSP) stage channel per sub-array per supported beam.

28. The antenna array according to claim 1, configured such that activation of one or more radiating elements within a sub-array controls a radiation pattern of the associated antenna element within the main array.

29. The antenna array according to claim 1, further comprising control circuitry configured dynamically to activate different numbers of radiating elements within the sub-arrays according to power and performance requirements.

30. The antenna array according to claim 12, wherein M=3 and N=6.

31. The antenna array according to claim 30, wherein six antenna modules are provided on each tiled section of the substrate.

32.-40. (canceled)

41. A system comprising a plurality of satellite communications terminals each comprising the multi-beam antenna array of claim 1, each satellite communications terminal having a digital waveform port, wherein:
the satellite communications terminals are electrically interconnected;
one of the satellite communication terminals is provided with a modem and designated as a primary terminal;
remaining satellite communications terminals of the plurality of satellite communications terminals are designated as secondary terminals and connected to the primary terminal in a tree or cascade manner to accept transmit signals and/or to provide receive signals; and
the primary terminal is configured to combine the signals from the secondary terminals such that the plurality of satellite communications terminals operate together as a single effective terminal.

42.-43. (canceled)

44. A method of operating a multi-beam antenna array, the multi-beam antenna array comprising a main array of antenna modules, each antenna module comprising a plurality M of individually-steerable antenna elements, wherein the antenna modules are arranged in the main array with N-fold rotational symmetry, wherein the antenna elements are arranged within each module with M-fold rotational symmetry, and wherein each antenna element comprises a sub-array of radiating elements, the method comprising:
i) selectively activating the radiating elements by control circuitry to generate a beam for transmitting and/or receiving data traffic to/from a satellite by way of a satellite link;
ii) monitoring, by the control circuitry, the data traffic and comparing instantaneous data traffic against a capacity of the satellite link;
iii) monitoring, by the control circuitry, a quality of the satellite link and a power consumption of the antenna array or the terminal or the system; and
iv) dynamically increasing or decreasing, by the control circuitry, a number of activated radiating elements in optimize performance efficiency.

45. A method of operating a multi-beam, multi-link satellite communications terminal, comprising:
i) establishing a first link between the terminal and a first satellite by way of a first beam from the terminal;
ii) unlocking a second beam from the terminal by way of a software key, the second beam being directed differently from the first beam;
iii) establishing a second link between the terminal and a second satellite so as to enable increased throughput to the terminal.

46. A method of operating a multi-beam satellite communications terminal, comprising:
i) establishing a link between the terminal and a satellite by way of a first beam from the terminal;
ii) generating a second beam from the terminal and steering the second beam independently of the first beam;
iii) performing at least one of sky mapping, blockage detection, signals intelligence processing, positioning-navigation-timing, interference detection and mitigation by way of the second beam while maintaining the link by way of the first beam.
